(19) United States
(12) Patent Application Publication
(10) Pub. No.: US 2011/0070465 A1
(43) Pub. Date: Mar. 24, 2011

(54) PROTECTION CIRCUIT MODULE AND BATTERY INCLUDING THE PROTECTION CIRCUIT MODULE AND METHOD OF MANUFACTURING THE BATTERY

(75) Inventor: Il Seong Kim, Gyeonggi-do (KR)

(73) Assignee: FUTURE LINE CO., LTD., Hwaseong-si, Gyeonggi-do (KR)

(21) Appl. No.: 12/673,761

(22) PCT Filed: Mar. 13, 2008
(86) PCT No.: PCT/KR08/01418

§ 371 Date: Feb. 16, 2010

(30) Foreign Application Priority Data
Aug. 17, 2007 (KR) 10-2007-0082792

(51) Int. Cl. H01M 10/42; H02H 7/18; H01M 10/04; H01R 43/00

(52) U.S. Cl. 429/7; 361/56; 29/623.1; 29/877

(57) ABSTRACT

This document describes a protection circuit module including an integrated protection circuit chip and a secondary battery. According to execution examples in this document, the foregoing integrated protection circuit chip is attached at the bottom of a protection circuit module, and penetration hole equivalent to the projection of a battery cell is formed in the center of the protection circuit module. With this protection circuit module, it is possible to have a battery that the integrated protection circuit chip of the protection circuit module is included in the groove which is formed in the battery cell, and the projection of the battery cell is inserted into the penetration hole of the protection circuit module.

### TECHNICAL FIELD

This document relates, in general, a protection circuit module, a battery including the same and a method for manufacturing the battery.

### BACKGROUND ART

For a secondary battery, for example, lithium ion battery, typically, a battery cell constituting the battery has an electric terminal projected in the upper center, and the outside of the battery cell itself forms another electric terminal. In other words, the battery cell, which is composed of a square-shape can (e.g., aluminum), itself forms one single terminal (e.g. positive terminal) and another terminal (e.g., negative terminal) is projected in the upper center of the battery cell.

Let me introduce an example of how to manufacture a battery cell. First, an electrode assembly is inserted into a square-shape can whose top is open, and the open top is covered and seal up with a top cap. And electrolyte is injected in the injection port of electrolyte perforated on one side of the top side, and sealing is performed, and epoxy resins are applied on it. Since the top cap connected to the square-shape can is electronically connected, the top cap also forms a positive terminal, and this positive terminal is electronically separated by insulator from the negative terminal.

Safety should be taken into consideration because a battery for example, a lithium secondary battery contains various inflammable materials, so that it is in danger of heat generation and explosion due to overcharge, overcurrent and other physical external shock. In order to efficiently control an abnormal state such as overcharge, accordingly, the lithium secondary battery has a PCM (Protection Circuit module) embedded into the battery cell.

PCM, a switching element in charge of controlling current, is composed of an FET (Field Effect Transistor) and a manual transistor such as voltage detector, resistance and battery, and it cuts off overcharge, overdischarge, overcurrent, short circuit and reverse voltage to prevent battery explosion or overheating, or leakage and the characteristic of charge and discharge from getting worse, and prevents its electrical performance from being deteriorated and from being behaved physically and chemically. Then, dangers are removed to lengthen the life of use.

This PCM is configured as a PCB (Printed Circuit Board) structure that PCM in charge of controlling overcharge, overdischarge and overcurrent of a battery is printed on the rectangle structure of epoxy compounds.

For the existing PCM, projected elements are intricately installed at the bottom of the PCB. Accordingly, the existing PCM is not directly connected to a battery cell and requires a structure or connection member for connecting them.

### DISCLOSURE OF INVENTION

### Technical Problem

Accordingly, this document has been made keeping in mind the above problems occurring in the prior art, and an object of this document is to provide a protection circuit module and a battery including the same.

In addition, another object of this document is to provide a protection circuit module for automatically manufacturing a battery and a method for manufacturing a battery using the protection circuit module.

### Technical Solution

In order to accomplish the above object, the present invention provides a Protection Circuit Module, comprising an integrated protection circuit chip for controlling overcharge, overdischarge and overcurrent of a battery, wherein the integrated protection circuit chip is mounted on one side of the Protection Circuit Module which has a penetration hole at a corresponding position to a projection of a battery cell connected to the Protection Circuit Module.

The integrated protection circuit chip may be a Switched Protection Module (SPM).

The Protection Circuit Module may have an electrode lead connected to one side of the penetration hole.

The Protection Circuit Module may have at least one electrode lead connected to at least one side of both sides of the protection circuit module.

At least one electrode lead may be connected to be penetrated into the protection circuit module.

A height of the at least one electrode lead exposed to the protection circuit module may be higher than a height of the integrated protection circuit chip mounted in the protection circuit module.

In order to accomplish the above object, the present invention provides a battery, comprising the Protection Circuit Module according to any one of claims 1-6 and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

The battery cell may be embossing-processed on the side connected to the protection circuit module to have at least one groove, in which the integrated protection circuit chip of the protection circuit module is included.

An insulator may be included between the battery cell and the protection circuit module.

In order to accomplish the above object, the present invention provides a method for manufacturing the battery, the method comprising: inserting the projection of battery cell to the penetration hole of the Protection Circuit Module according to any one of claims 1-6 and connecting at least one electrode lead of the Protection Circuit Module and at least one electrode terminal of the battery cell.

The method may further comprise attaching a top cover, a bottom cover and a label simultaneously to the battery cell to which the protection circuit module is connected.

### ADVANTAGEOUS EFFECTS

According to a protection circuit module, and a battery including the same, and a method for manufacturing a battery described in this document, it is possible to reduce the number of parts and the count of welding in the process of connecting a battery cell and a protection circuit module.

In addition, attaching an integrated protection circuit chip will enable the miniaturization of the protection circuit module, and consequently the total size of a battery can be reduced because it is possible to decrease the number and size of parts mounted in the battery cell. Or it is possible to prolong the life of a cell by increasing the capacity of the cell as much as the size of the part reduced.

It is also possible to increase daily production by reducing the number of process line when manufacturing batteries. Also simple process will enable an automation of the manufacturing process and it is expected that the stated daily production can be increased through automatic process.

Furthermore, price can be reduced and price competitiveness can be upgraded through reduction of the manufacturing process, and there will be many chances of exchanging a battery cell and reusing a protection circuit module.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates the top and bottom perspective drawing of a protection circuit module according to an example of the present invention.

FIG. 2 illustrates the top perspective drawing of a protection circuit module according to an example of the present invention.

FIG. 3 illustrates the top perspective drawing of a protection circuit module according to an example of the present invention.

FIG. 4 illustrates the vertical section drawing of the combination of a protection circuit module and a battery cell according to an example of the present invention.

FIG. 5 illustrates the vertical section drawing of the connection of a protection circuit module and a battery cell according to an example of the present invention.

FIG. 6 illustrates the vertical section drawing of the connection of a protection circuit module and a battery cell according to an example of the present invention.

FIG. 7 illustrates the vertical section drawing of the connection of a protection circuit module and a battery cell according to an example of the present invention.

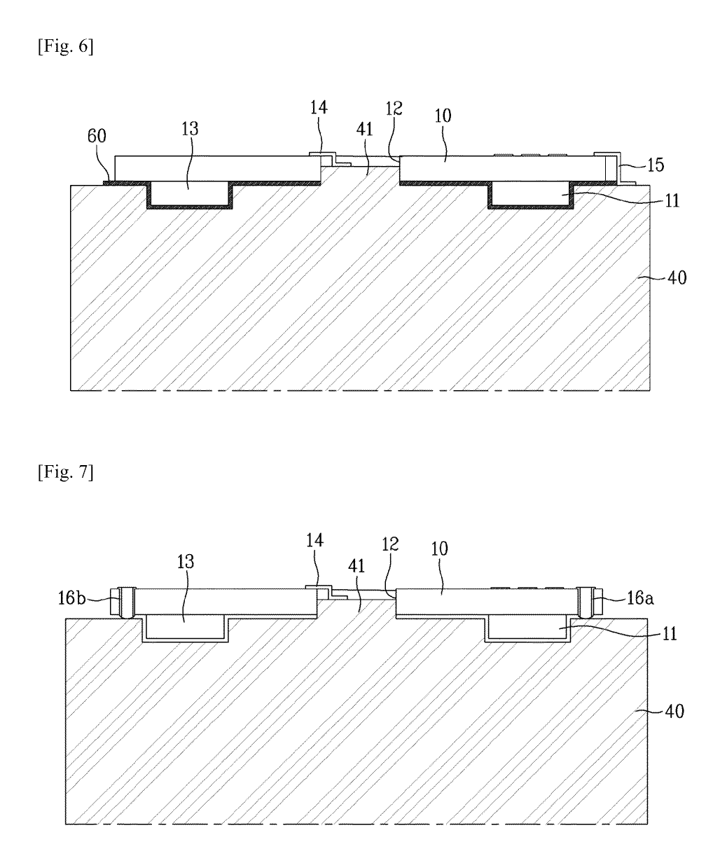

FIG. 4 illustrates the vertical section drawing of the connection of a protection circuit module and a battery cell according to an example of the present invention.

FIG. 9 illustrates the perspective drawing of the process for electrically connecting a protection circuit module to the battery cell of a battery according to an example of the present invention.

FIG. 10 illustrates a flow chart of a method for manufacturing a battery according to an example of the present invention.

### MODE FOR THE INVENTION

Hereinafter, embodiments of a protection circuit module, a battery including the same and a method for manufacturing the battery, according to the present invention will be described in detail with reference to the attached drawings.

The protection circuit module in accordance with an example of the present invention includes protection circuits which are miniaturized and integrated and then attached at the bottom of the PCB (Printed Circuit Board). In other words, the protection circuits are mounted as an integrated protection circuit chip on one side of the protection circuit module. Hereinafter, the integrated protection circuit chip is referred to as SPM (Switched Protection Module. However, this integrated protection circuit chip can be named SPC (Switched Protection circuit Chip) and IPCM (Integrated Protection Circuit Module), and the scope of the present invention is not limited to the name SPM.

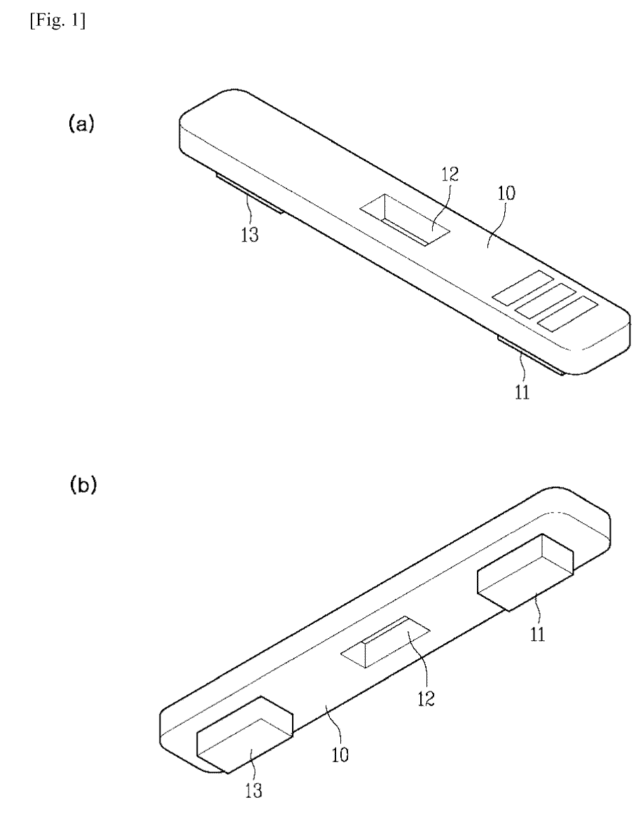

FIG. 1 illustrates the top and bottom perspective drawings of a protection circuit module according to an example of the present invention.

FIG. 1 (a) illustrates the top perspective view of the protection circuit module according to one example of the present invention. By referring to FIG. 1 (a), the penetration hole (12) is formed in the protection circuit module (10) according to one example of the present invention. Here, the penetration hole (12) formed in the protection circuit module (10) should correspond with the location and size equivalent to the projection of a battery cell which is connected to the protection circuit module (10). That is, it is preferably to form the location and size in order that the projection of the battery cell can be inserted in penetration hole when connecting the protection circuit module (10) to the battery cell.

For example, generally, a battery cell is configured to have a projection corresponding to positive terminal or negative terminal in the center of the side connected to the protection circuit module, that is, the top of a battery cell. In this case, the protection circuit module (10) in accordance with an example of the present invention will have a penetration hole (12) in size equivalent to the projection size corresponding to the positive terminal or negative terminal projected in the center of a battery cell.

FIG. 1 (b) illustrates the bottom perspective view of the protection circuit module (10) according to one example of the present invention. By referring to FIG. 1 (b), a penetration hole (12) equivalent to the projection of a battery cell connected to the protection circuit module (10) is formed in the protection circuit module (10), as in FIG. 1 (a), and SPM (11) is attached. As stated, if SPM (11) is used as a protection circuit chip, it is possible to attach an integrated and simple structure of chip on one side of the protection circuit module.

If an extra element or a circuit chip is required separately with SPM (11), it can be attached with SPM (11) at the bottom of the protection circuit module (10). Preferably, this extra element or a circuit chip is formed in the same simple hexahedron structure as SPM (11).

FIG. 1 (b) illustrates that a chip (13) equivalent to this extra element or circuit chip is configured as a hexahedron structure, and it is attached at the central bottom of the protection circuit module (10) in the reverse direction of SPM (11). It is sure that the structure and location of this chip (13) can be changed.

In addition, the size of projected elements (11, 13) of the protection circuit module (10) illustrated in FIG. 1 (b) is magnified for easy explanation, and the scope of the present invention is not limited to the illustration.

According to an example of the present invention stated, the positive terminal and negative terminal of a battery cell should be electrically connected to the protection circuit module in order to attach the protection circuit module to the battery cell for operation. Hereinafter, the element that electrically connects the positive terminal and negative terminal of the battery cell is referred to as electrode lead. And in the explanation below, it is supposed that the projection of the battery cell is the negative terminal.

Because the protection circuit module in accordance with one example of the present invention has a penetration hole (12) for the projected electrode in the center of a battery cell, an electrode lead may be formed in connection of the penetration hole and the electrode electrically.

In other words, if the size of penetration hole (12) of the protection circuit module (10) is the same as that of the negative terminal of the battery cell, in detail, if the circumference of the penetration hole (12) and the negative terminal is equal, attach an electrode lead (non-illustrated) for electric connection to one side or both sides of penetration hole (12) in touch with the negative terminal.

This allows the negative terminal of a battery cell to be connected to the protection circuit module through the electrode lead positioned between the penetration hole (12) and the negative terminal.

However, since this method is effective only if the circumference of the penetration hole (12) and the negative terminal is equal, other examples of electrode lead that can apply a protection circuit module according to example of the present invention will be disclosed.

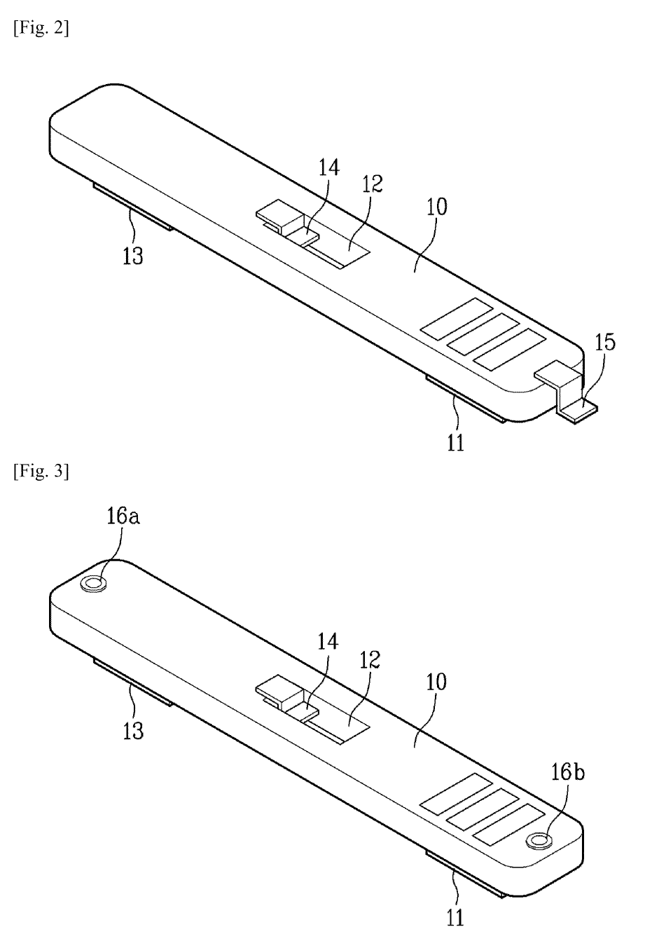

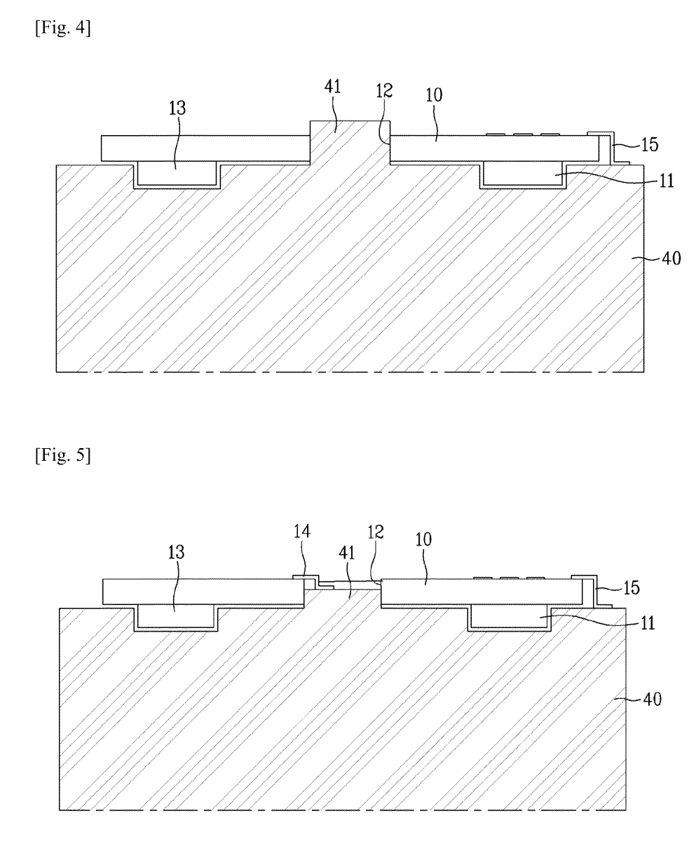

By referring to FIG. 2 and FIG. 3, it will be explained that a protection circuit module including an electrode lead that can eclectically connect the positive terminal and the negative terminal of a battery cell.

FIG. 2 illustrates the top perspective drawing of a protection circuit module according to an example of the present invention.

Here, description of major components of the protection circuit module is the same as that described in FIGS. 1 (a) and (b). Accordingly, FIG. 2 describes only an electrode lead to be added to the protection circuit module of FIGS. 1 (a) and (b).

By referring to FIG. 2, an example of penetration hole (12) connected to the negative terminal of a battery cell and an example of electrode lead (14, 15) attached to one side of the protection circuit module in rhomboidal direction are disclosed.

For the electrode lead (14) attached to the penetration hole (12), one side should be connected to the protection circuit module (10) and the other side should be connected to the negative terminal of a battery cell. The electrode lead (14) attached to the penetration hole (12) can be named negative lead (14).

For the electrode lead (15) attached to one side of the protection circuit module in a rhomboidal direction, one side should be connected to the protection circuit module (10) and the other side to the positive terminal of the battery cell. Likewise, the electrode lead (15) attached to one side of the protection circuit module in rhomboidal direction can be called positive lead (15).

Typically, since the negative terminal of a battery cell is configured as projection structure, the length of the negative lead (14) is shorter than that of the positive lead (15). Also, FIG. 2 illustrates only that the positive lead (15) is attached to one side of the protection circuit module in rhomboidal direction, and it is possible to attach the positive lead to both sides in some cases.

As illustrated in FIG. 2, because the penetration hole (12) of a protection circuit module or the electrode lead attached on the side in rhomboidal direction is curved to configure the downward vertical part while being attached to the protection circuit board, it is configured to be in touch with the negative terminal or positive terminal of a battery cell.

FIG. 3 illustrates the top perspective drawing of a protection circuit module according to an example of the present invention.

FIGS. 1 (a) and (b) describe only an electrode lead which is added to the protection circuit module.

By referring to FIG. 3, the negative lead (14) is attached to the penetration hole (12) to which the negative terminal of a battery cell is connected, as illustrated in example of FIG. 2. Unlike FIG. 2, however, the positive lead (16a, 16b) is inserted into both ends of the protection circuit module in rhomboidal direction. For example, this positive lead is inserted in the penetration hole equivalent to the positive lead structure of the protection circuit module.

FIG. 3 illustrates an example of an electrode lead (16a, 16b) being inserted into both ends of the protection circuit module in rhomboidal direction, but it is also possible to insert an electrode lead (16a, 16b) into only one end of the protection circuit module in rhomboidal direction. However, if an electrode lead is formed only at one end, a prosthetic device can be added for stable structure when assembling a protection circuit module to the battery cell.

According to an example of the present invention, the positive lead (16a, 16b) can be configured as empty cylindrical or hexahedron structure. To fix the protection circuit module to the battery cell by welding, it is desirable to block the bottom of the positive lead, that is, the part connected to the top of a battery cell.

In examples stated above, the electrode lead is an element which is used for electric connection, and it is called an electrode tap or connection terminal, but not limited to electrode lead.

By referring to FIG. 4 or FIG. 8, how to connect a protection circuit module to the battery cell according to stated example of the present invention will be explained.

FIG. 4 illustrates the vertical section drawing of the combination of a protection circuit module and a battery cell according to an example of the present invention.

A battery cell (40) is configured to have a projection (41), as the negative terminal, in the upper center. According to example of the present invention, the top of the battery cell (40) is embossing-processed to have a groove equivalent to the size of at least one projected element (11, 13), which is attached to the bottom of the protection circuit module (10) connected to the battery cell (40).

By referring to FIG. 4, for instance, if two projected elements (11, 13) corresponding to SPM are attached to the both ends of the protection circuit module, in rhomboidal direction, as illustrated in drawing, the top of the battery cell (40) is embossing-processed to have a groove a little deeper than that of the two projected elements (11, 13).

According to example of the present invention, if a protection circuit module (10) is mounted on the embossing-processed battery cell (40), the negative terminal (41) of the battery cell is inserted into the penetration hole (12) of the protection circuit module, and projected elements (11, 13) at the bottom of the protection circuit module are inserted into the groove of the embossing-processed battery cell.

According to relative height of the negative terminal (41) and protection circuit module (10), the negative terminal (41) can be projected from the top of the protection circuit module, as shown in FIG. 4.

If necessary, a negative lead or at least one positive lead (15) can be attached. At this point, the positive lead (15) makes an electric connection between the protection circuit module (10) and the battery cell (40). Here, the negative lead is not illustrated because it is positioned between the penetration hole (13) of protection circuit module (10) and the negative lead (41) of the battery cell.

When connecting the battery cell (40) with the protection circuit module (10), the battery cell (40) can be directly in touch with the protection circuit module (10), but it is recommended to connect the battery cell (40) to the protection circuit module (10) at regular intervals, considering danger such as electric short circuit. For example, it is possible to keep regular intervals between the battery cell (40) and the protection circuit module (15) by adjusting the length of the positive lead (15) attached to one side or both sides of the protection circuit module.

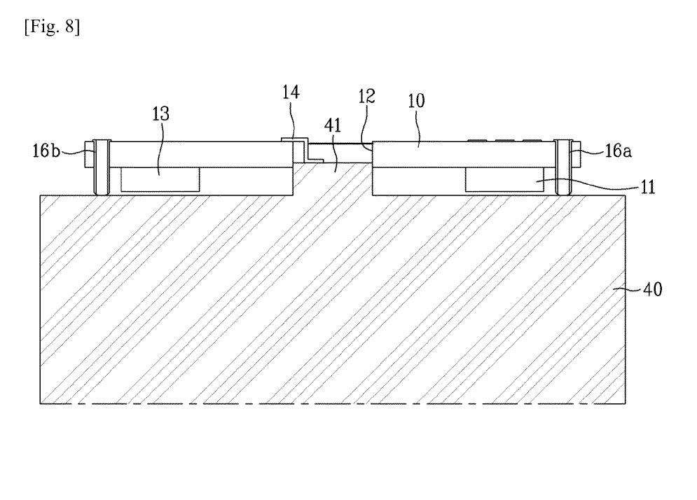

FIG. 5 illustrates the vertical section drawing of the combination of a protection circuit module and a battery cell according to example of the present invention.

By referring to FIG. 5, it is similar to the structure described in FIG. 4, but there is a difference in the structure of the negative lead (14) that makes a connection between the protection circuit module (10) and the battery cell (40). One end of the negative lead (14) is attached to the penetration hole (12) of the protection circuit module (10) and the other end is attached to the negative terminal of the battery cell (41).

In this case, as stated above, the length of the negative lead (14) is shorter than that of the positive lead (15) because the negative terminal (41) is projected, compared to the positive terminal.

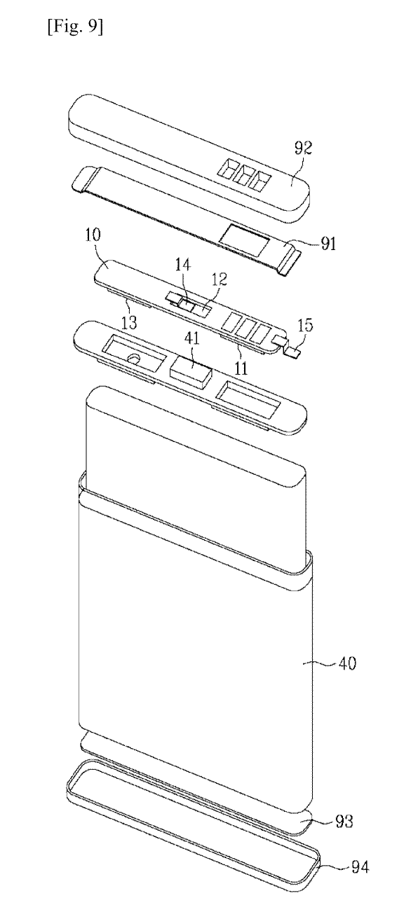

FIG. 6 illustrates the vertical section drawing of the combination of a protection circuit module and a battery cell according to example of the present invention.

By referring to FIG. 6, it is similar to the structure described in FIG. 5, but you can see that there is additional insulator (60) between the protection circuit module (10) and the battery cell (40) in order to prevent them from being directly in touch. This insulator (60) can be attached to the top of the battery cell (40) or to the bottom of the protection circuit module (10) in advance, or it can be attached in the process of assembly.

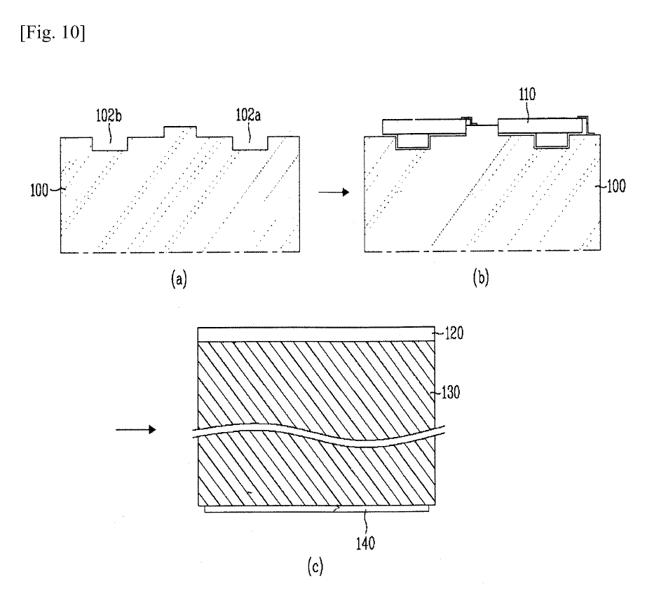

FIG. 7 illustrates the vertical section drawing of the combination of a protection circuit module and a battery cell according to example of the present invention.

By referring to FIG. 7, it is similar to the structure described in FIG. 5, but there is a difference in the structure of the positive lead (16a, 16b) that makes a connection between the protection circuit module (10) and the positive terminal (41) of the battery cell (40). In other words, FIG. 7 shows the combination structure that the positive lead (16a, 16b) which is attached to one end or both ends of the protection circuit module, as described in FIG. 3.

Positive lead (16a, 16b) can be an empty cylindrical or hexahedron structure and a floor-blocked structure. The shape of the positive lead (16a, 16b) can be changed in many forms.

At this point, the length of the positive lead (16a, 16b) is the same as the thickness of the protection circuit module (10) or longer. If the length of the positive lead (16a, 16b) is longer than the thickness of the protection circuit module (10), it is possible to keep regular intervals between the protection circuit module (10) and the battery cell (40). In other words, regular intervals are kept between the protection circuit module (10) and the battery cell (40) by exposing a part of the positive lead (16a, 16b) to the bottom of the protection circuit module (10).

FIG. 8 illustrates the vertical section drawing of the combination of a protection circuit module and a battery cell according to example of the present invention.

FIG. 8 shows an example of the connection between the protection circuit module (10) and the battery cell (40) if the top of the battery cell (40) is not embossing-processed.

In this case, that is, the height between the protection circuit module (10) and the battery cell (40), except projected elements (11, 13), will be higher than the stated examples, for instance, compared to FIG. 7. Accordingly, the length of the negative lead (14) will be longer than FIG. 7 and the height of the positive lead (80a, 80b) will be higher than FIG. 7. In other words, it is recommended that the height of the positive lead (80a, 80b), exposed to the side of the connection between the protection circuit module (10) and battery cell, should be higher than that of the projected elements (11, 13) attached to the above protection circuit module.

Here, a plane-type positive lead can be used. At this point, the length of the positive lead used can be adjusted, and it is advisable to use longer one to ensure that the protection circuit module (10) and the battery cell (40) can be connected electrically.

In other ways, if the top of the battery cell (40) is not embossing-processed as shown in FIG. 8, it is possible to connect the protection circuit module (10) and the battery cell (40) to ensure that the top of the protection circuit module (10) without projected elements (11, 13) can be attached to the top of the battery cell (40), with the protection circuit module (10) upside down.

According to example of the present invention, a more effective method can be used to connect the protection circuit module to the battery cell because the connection side of the protection circuit module with SPM and the battery cell is simply structured.

FIG. 9 illustrates the perspective drawing of the process for electrically connecting a protection circuit module to the battery cell of a battery according to an example of the present invention

By referring to FIG. 9, a battery cell (40) itself forms one single terminal because it is composed of a square-shape can (e.g., aluminum), and another terminal (e.g., negative terminal: 41) is projected in the upper center. In addition, the top of the battery cell (40) is embossing-processed, so that the projected element attached to the bottom of the protection circuit module (10) can be included.

A protection circuit module (10) is attached to the top of the battery cell (40) according to example of the present invention. Protection circuit module (10) has a penetration hole (12) for the negative terminal (41) projected in the upper center of the battery cell (40). Projected elements including SPM (11) can be attached to the bottom of the protection circuit module (10). Also, the protection circuit module includes electrode leads for electric connection between the battery cell (40) and the protection circuit module (10), that is, a negative lead and at least one positive lead. The negative lead and at least one positive lead are in touch with the negative terminal (41) and positive terminal of the battery cell (40), respectively.

And, the top cover (92) and the bottom cover (94) are attached to the top and the bottom of the battery cell (40) to which the protection circuit module (10) is connected. Adhesive materials (91, 93) can be used to attach the top cover (92) and bottom cover (94). This adhesive material can be separated attached as illustrated, and alternatively, adhesives can be applied inside the top cover (92) and bottom cover (94).

Even if not illustrated in the drawing, if necessary, an insulator can be positioned between the protection circuit module (10) and the battery cell (40), or between the protection circuit module (10) and the top cover (92).

FIG. 10 illustrates a flow chart of a method for manufacturing a battery according to example of the present invention.

By referring to FIG. 10, first, embossing is processed on the top side of the battery cell (100) at the step of (a). For embossing processing, a groove (102a, 102b) subsided into the cell is formed on the top side of the battery cell (100).

And at the step of (b), mount the protection circuit module (110) on the top of the battery cell (100) and connect one of the negative lead and at least positive leads of the protection circuit module (110) to one of the negative terminal and positive terminal of the battery cell.

At this point, the projected negative terminal of the battery cell (100) is inserted into the penetration hole in the center of the protection circuit module (110), and the projected elements attached to the bottom of the protection circuit module (110) are connected to the inside of a groove (102a, 102b) created through the embossing process at the step of (a).

Battery cell (100) can be connected to the protection circuit module (110) in many different ways, for example, welding such as spot welding and laser welding, adhesive connection using adhesives, and making a connection hole and a connection groove on the battery cell (100) and the protection circuit module (110), respectively, but not limited to such methods.

At the step of (c), attach the top cover (120), bottom cover (140) and label (130) to the top, the bottom and the circumference side of the battery cell to which the protection circuit module is connected. Label (130) makes the protection circuit module (110) adhere closely to the battery cell (100) and protect the battery cell (100). Label (130) can contain battery use or manufacturer information.

At this point, it is possible to attach the top cover (120), bottom cover (140) and label (130) simultaneously according to automatic process.

As stated, detailed information on desirable execution of the present invention is provided to ensure that makers can implement and perform the present invention. Even if it is described above by referring to desirable execution method of the present invention, makers familiar to the technology can modify and change the present invention within the range of idea and area of the present invention specified in the following Scope of the Liberties.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A Protection Circuit Module, comprising: an integrated protection circuit chip for controlling overcharge, overdischarge and overcurrent of a battery, wherein the integrated protection circuit chip is mounted on one side of the Protection Circuit Module which has a penetration hole at a corresponding position to a projection of a battery cell connected to the Protection Circuit Module.

2. The Protection Circuit Module according to claim 1, wherein the integrated protection circuit chip is a Switched Protection Module (SPM).

3. The Protection Circuit Module according to claim 1, wherein the Protection Circuit Module has an electrode lead connected to one side of the penetration hole.

4. The Protection Circuit Module according to claim 1, wherein the Protection Circuit Module has at least one electrode lead connected to at least one side of both sides of the protection circuit module.

5. The Protection Circuit Module according to claim 4, wherein at least one electrode lead is connected to be penetrated into the protection circuit module.

6. The Protection Circuit Module according to claim 5, wherein a height of the at least one electrode lead exposed to the protection circuit module is higher than a height of the integrated protection circuit chip mounted in the protection circuit module.

7. A battery, comprising: the Protection Circuit Module according to claim 1; and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

8. The battery according to claim 7, wherein the battery cell is embossing-processed on the side connected to the protection circuit module to have at least one groove, in which the integrated protection circuit chip of the protection circuit module is included.

9. The battery according to claim 7, wherein an insulator is included between the battery cell and the protection circuit module.

10. A method for manufacturing a battery, the method comprising: inserting the projection of battery cell to the penetration hole of the Protection Circuit Module according to claim 1 and connecting at least one electrode lead of the Protection Circuit Module and at least one electrode terminal of the battery cell.

11. The method according to claim 10, further comprising: attaching a top cover, a bottom cover and a label simultaneously to the battery cell to which the protection circuit module is connected.

12. A battery, comprising: the Protection Circuit Module according to claim 2; and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

13. A battery, comprising: the Protection Circuit Module according to claim 3; and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

14. A battery, comprising: the Protection Circuit Module according to claim 4; and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

15. A battery, comprising: the Protection Circuit Module according to claim 5; and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

16. A battery, comprising: the Protection Circuit Module according to claim 6; and a battery cell which has a projection at corresponding position with the penetration hole of the Protection Circuit Module, wherein the battery cell is electrically connected to the Protection Circuit Module for the projection of battery cell to be inserted in the penetration hole of the Protection Circuit Module.

17. A method for manufacturing a battery, the method comprising: inserting the projection of battery cell to the penetration hole of the Protection Circuit Module according to claim 2 and connecting at least one electrode lead of the Protection Circuit Module and at least one electrode terminal of the battery cell.

18. A method for manufacturing a battery, the method comprising: inserting the projection of battery cell to the penetration hole of the Protection Circuit Module according to claim 3 and connecting at least one electrode lead of the Protection Circuit Module and at least one electrode terminal of the battery cell.

19. A method for manufacturing a battery, the method comprising: inserting the projection of battery cell to the penetration hole of the Protection Circuit Module according to claim 4 and connecting at least one electrode lead of the Protection Circuit Module and at least one electrode terminal of the battery cell.

20. A method for manufacturing a battery, the method comprising: inserting the projection of battery cell to the penetration hole of the Protection Circuit Module according to claim 5 and connecting at least one electrode lead of the Protection Circuit Module and at least one electrode terminal of the battery cell.
